(19) United States
(12) Patent Application Publication
(10) Pub. No.: US 2025/0165514 A1
(43) Pub. Date: May 22, 2025

(54) DATA PROCESSING METHOD, APPARATUS, DEVICE AND STORAGE MEDIUM

(71) Applicant: Beijing Zitiao Network Technology Co., Ltd., Beijing (CN)

(72) Inventors: Juan AI, Beijing (CN); Wei FANG, Beijing (CN); Yuxin JING, Beijing (CN); Yi ZHENG, Beijing (CN); Tianyi XIONG, Beijing (CN); Fanshen ZENG, Beijing (CN)

(21) Appl. No.: 18/954,245

(22) Filed: Nov. 20, 2024

(30) Foreign Application Priority Data
Nov. 21, 2023 (CN) 202311560020.X

(51) Int. Cl. G06F 16/33; G06F 16/338; G06F 40/279

(52) U.S. Cl. CPC G06F 16/3344; G06F 16/338; G06F 40/279

(57) ABSTRACT

The present disclosure provides a data processing method, apparatus, device and a storage medium. The method includes: receiving a target message for a target object in a target session, wherein the target message comprises a keyword set; obtaining target information of the target object according to the keyword set, wherein the target information matches keywords in the keyword set; displaying a reply message, which contains the target information, in the target session.

### CROSS-REFERENCE TO RELATED APPLICATION

The present application claims priority of Chinese Patent Application No. 202311560020.X, filed on Nov. 21, 2023, and the entire content disclosed by the Chinese patent application is incorporated herein by reference as part of the present application for all purposes under the U.S. law.

### TECHNICAL FIELD

The present disclosure relates to the computer field, and in particular to a data processing method, apparatus, device and a storage medium.

### BACKGROUND

With the development of computer technology, more and more enterprises or entities choose to use databases for human resource management. Specifically, a human resource information database can be established and the relevant information of employees can be stored in the human resource information database, so that the relevant information of employees can be managed through database tools.

However, the above method mainly relies on keyword search in the process of information retrieval, which has the problem of low retrieval efficiency.

### SUMMARY

At least one embodiment of the present disclosure provides a data processing method, which comprises: receiving a target message for a target object in a target session, wherein the target message comprises a keyword set; obtaining target information of the target object according to the keyword set, wherein the target information matches keywords in the keyword set; displaying a reply message, which contains the target information, in the target session.

For example, in the data processing method provided by at least one embodiment of the present disclosure, the keyword set comprises overview keywords and/or index keywords.

For example, in the data processing method provided by at least one embodiment of the present disclosure, the obtaining the target information of the target object according to the keyword set comprises: obtaining overview information of the target object according to the overview keywords, wherein the overview information comprises at least one selected from a group consisting of: basic work information, work content, work ability and work performance; or, obtaining index information of the target object according to the index keywords, wherein the index information comprises at least one selected from a group consisting of: personnel information, performance information, recruitment information, OKR information and salary information.

For example, in the data processing method provided by at least one embodiment of the present disclosure, the displaying a reply message, which contains the target information, in the target session comprises: displaying a graph, a table and/or an information card in the reply message, wherein the graph, the table and/or the information card are generated based on the overview information or the index information.

For example, in the data processing method provided by at least one embodiment of the present disclosure, the obtaining the target information of the target object according to the keyword set comprises: sending intention diffusion information to a first model, wherein the intention diffusion information is obtained according to a first keyword in the keyword set; receiving intention diffusion result information sent by the first model, wherein the intention diffusion result information comprises at least one diffusion keyword, and the diffusion keyword is obtained by performing intention diffusion on the first keyword; querying, according to the at least one diffusion keyword, to obtain diffusion information of the target object, wherein the target information comprises the diffusion information.

For example, in the data processing method provided by at least one embodiment of the present disclosure, the querying, according to the at least one diffusion keyword, to obtain diffusion information of the target object comprises: obtaining diffusion information of the target object from an information source corresponding to the diffusion keyword.

For example, in the data processing method provided by at least one embodiment of the present disclosure, the reply message further comprises a reference region, and the reference region is used to display the diffusion information of the target object.

For example, in the data processing method provided by at least one embodiment of the present disclosure, the reference region comprises at least one diffusion information selected from a group consisting of: personnel information, performance information, recruitment information, OKR information and salary information.

For example, the data processing method provided by at least one embodiment of the present disclosure further comprises: displaying, in response to a first trigger operation on the diffusion information of the reference region, a content of the diffusion information in the target session; or, invoking, in response to a second trigger operation on the diffusion information of the reference region, an information page of the information source of the diffusion information, and displaying the content of the diffusion information on the information page.

For example, in data processing method provided by at least one embodiment of the present disclosure, the keyword set further comprises a second keyword, and the obtaining target information of the target object according to the target keyword comprises: querying, according to the second keyword, to obtain accurate information of the target object, wherein the target information further comprises the accurate information.

For example, in the data processing method provided by at least one embodiment of the present disclosure, the target information comprises identification information of the target object.

For example, the data processing method provided by at least one embodiment of the present disclosure further comprises: determining at least one candidate object according to the identification information; sending object confirmation request information to a client terminal, wherein the object confirmation request information is obtained according to information of the at least one candidate object; obtaining object confirmation response information sent by the client terminal, wherein the object confirmation response information indicates the target object; determining the target object according to the object confirmation response information.

For example, in the data processing method provided by at least one embodiment of the present disclosure, the target information comprises object retrieval information; the method further comprises: sending intention parse information to a second model, wherein the intention parse information is generated based on the object retrieval information; receiving intention information sent by the second model, wherein the intention information is determined according to the object retrieval information; determining the target object according to the intention information, wherein information of the target object matches the intention information.

For example, in the data processing method provided by at least one embodiment of the present disclosure, after obtaining the target information of the target object and before displaying the reply message, the method further comprises: sending object summary information to a third model, wherein the object summary information is obtained according to the target information of the target object; receiving object summary response information sent by the third model, wherein the object summary response information comprises summarized target information of the target object; generating the reply message according to the summarized target information of the target object.

At least one embodiment of the present disclosure further provides an electronic device, comprising: one or more processors; a storage apparatus, storing one or more programs thereon, wherein the one or more programs, when executed by the one or more processors, cause the one or more processors to realize the data processing method provided by any one of embodiments of the present disclosure.

For example, in the electronic device provided by at least one embodiment of the present disclosure, the keyword set comprises overview keywords and/or index keywords.

For example, in the electronic device provided by at least one embodiment of the present disclosure, the obtaining the target information of the target object according to the keyword set comprises: obtaining overview information of the target object according to the overview keywords, wherein the overview information comprises at least one selected from a group consisting of: basic work information, work content, work ability and work performance; or, obtaining index information of the target object according to the index keywords, wherein the index information comprises at least one selected from a group consisting of: personnel information, performance information, recruitment information, OKR information and salary information.

For example, in the electronic device provided by at least one embodiment of the present disclosure, the displaying a reply message, which contains the target information, in the target session comprises: displaying a graph, a table and/or an information card in the reply message, wherein the graph, the table and/or the information card are generated based on the overview information or the index information.

For example, in the electronic device provided by at least one embodiment of the present disclosure, the obtaining the target information of the target object according to the keyword set comprises: sending intention diffusion information to a first model, wherein the intention diffusion information is obtained according to a first keyword in the keyword set; receiving intention diffusion result information sent by the first model, wherein the intention diffusion result information comprises at least one diffusion keyword, and the diffusion keyword is obtained by performing intention diffusion on the first keyword; querying, according to the at least one diffusion keyword, to obtain diffusion information of the target object, wherein the target information comprises the diffusion information.

At least one embodiment of the present disclosure provides a computer-readable storage medium, wherein a computer program is stored thereon, wherein the program, when executed by a processor, realizes the data processing method provided by any one of embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a scenario diagram of an application scenario provided by an embodiment of the present disclosure;

FIG. 2 is a flowchart of a data processing method provided by an embodiment of the present disclosure;

FIG. 3 is a flowchart of a method of displaying target information of a target object provided by an embodiment of the present disclosure;

FIG. 4 is a schematic diagram of a data processing apparatus provided by an embodiment of the present disclosure; and

FIG. 5 is a schematic diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

When conducting human resource management, the user may need to view certain information of employees. For example, the user may need to view specific information of a specific employee or employees. For another example, the user may need to view the information of employees with certain attributes. At present, the user in charge of human resources management can browse the human resource database and select employees who meet the requirements therefrom.

For example, assuming that the position of employee A needs to be changed, the user in charge of human resources management may need to view the information of employee A. If employee A needs to be transferred to a management position, the user in charge of human resources management may need to view information that can reflect the management ability of employee A. If employee A needs to be transferred to a technical position related to front-end development, the user in charge of human resources management may need to view information that can reflect the technical ability of employee A, specifically, information that reflects the technical ability of employee A in front-end development.

For another example, assuming that there is a vacancy in position B, the user in charge of human resources management may need to view the information of the candidates for position B. If position B is a management position, the user in charge of human resources management may need to view the information of employees with strong management ability. If position B is a technical expert position, the user in charge of human resources management can view the information of employees with strong technical ability.

At present, the user needs to personally retrieve employee information from the human resource database. In the case where the human resource database includes information of a large number of employees, and/or each employee's information includes a large number of fields, it takes much time and effort to browse the human resource database, which has the problem of low efficiency. In particular, for large enterprises and other entities with a large number of employees, the human resource database may include multiple sub-databases, and the user may need to switch between sub-databases, which will further reduce efficiency.

In other scenarios, there is also a need to obtain certain information of a certain object, and there is also the problem of low efficiency mentioned above.

In order to solve the problems in the prior art, an embodiment of the present disclosure provides a data processing method, which will be described in detail with reference to the attached drawings in the specification.

As can be seen, the present disclosure has the following beneficial effects:

The present disclosure provides a data processing method, apparatus, device and a storage medium. Specifically, if a user wants to view information of a certain aspect (or multiple aspects) of an object, the user can send a target message in a target session. The target message is a message sent for a target object, which is used for requesting to view the information of the target object; moreover, the target message further includes a keyword set, and the information requested to be viewed by the target message corresponds to the keyword information. After the target message is obtained, the target information of the target object can be obtained according to the keyword set. The target information of the target object matches the keywords in the keyword set. Then, a reply message containing the target information can be displayed in the target session, so that the user can view the target information in the reply message through the target session. That is to say, if a user wants to view certain information of a certain object (or multiple objects), the user can send his/her own needs in the target session in the form of a target message, and see the target information desired to view in the target session. In this way, what information needs to be displayed to the user can be determined according to the user's needs, without the need for the user to manually retrieve the information to be viewed. Thus, automatic information retrieval can be achieved by parsing the user's intention, and the retrieval efficiency can be improved.

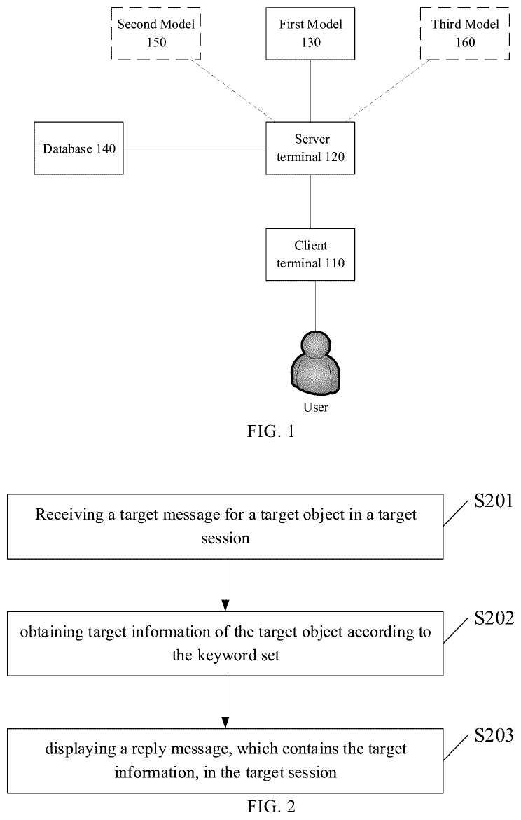

First, an exemplary application scenario of the embodiment of the present disclosure is introduced. Referring to FIG. 1, it is a schematic framework diagram of an exemplary application scenario provided by an embodiment of the present disclosure. In the implementation shown in FIG. 1, a client terminal 110, a server terminal 120, a first model 130 and a database 140 are included. The client terminal 110 and the server terminal 120 can be connected through a network, the server terminal 120 and the first model 130 can also be connected through a network, and the server terminal 120 and the database 140 can be connected through a network.

The client terminal 110 can run on a terminal device used by the user, for example, on the user's mobile phone, computer or other terminal devices. The server terminal 120 can run on a server or a server cluster, and is configured to provide services to the client terminal 110. Data can be exchanged between the client terminal 110 and the server terminal 120. The user can send a message using the client terminal 110. The message sent by the user on the client terminal 110 can be forwarded by the client terminal 110 to the server terminal.

The first model 130 can run on a server or a server cluster. Optionally, the server (or server cluster) for implementing the first model 130 and the server (or server cluster) for implementing the server terminal 120 can be the same or different. The first model 130 is used to provide services of the first model to the external, and the server terminal 120 can send to-be-processed data to the first model 130, so as to invoke the first model 130 to process the to-be-processed data, and return the processed data to the server terminal 120. Optionally, the first model can be a model with a Natural Language Processing (NLP) function, for example, a Language Model (LM).

The database 140 can also run on a server or a server cluster, and is used for storing data related to objects. Optionally, the database 140 can include a human resource database. Moreover, the server or server cluster running the database 140 and the server or server cluster running the server terminal 120 can be the same or different.

In some possible implementations provided by the embodiment of the present disclosure, the server terminal can invoke multiple models to determine the object display information. Accordingly, in the implementation shown in FIG. 1, a second model 150 and a third model 160 can also be included. The second model 150 and the third model 160 can be respectively connected to the server terminal 120 through a network. Because the second model 150 and the third model 160 are optional, they are redisplayed by dashed lines in FIG. 1.

The exemplary application scenario of the embodiment of the present disclosure has been described above, and the data processing method provided by the embodiment of the present disclosure will be exemplarily described below.

Referring to FIG. 2, FIG. 2 is a flowchart of a data processing method provided by an embodiment of the present disclosure. The embodiment of the present disclosure is applicable to an application scenario in which a user views information of an object through a server terminal. The data processing method can be executed by a data processing apparatus, and the data processing apparatus can be implemented by software.

Optionally, the data processing apparatus can be integrated into the client terminal or server terminal of the software. The client terminal of the software can run on a terminal device, and the server terminal of the software can run on a server or server cluster to provide corresponding services to the client terminal of the software. Optionally, the software can be Instant Messaging (IM) software with human resource management capabilities. Accordingly, the client terminal can be a client terminal of the IM software, and the server terminal can be a server terminal of the IM software. The user can send a message to the server terminal of the IM software through the client terminal of the IM software. Optionally, in the application scenario shown in FIG. 1, the data processing apparatus can be integrated into the client terminal 110 or the server terminal 120. In the following, it is taken as an example that the data processing apparatus is integrated into the client terminal 110. As shown in FIG. 2, the method specifically includes the following steps:

S201: Receiving a target message for a target object in a target session.

In the embodiment of the present disclosure, if a user wants to view the information of a specific object or view the information of objects that meets certain conditions, the user can input a target message through a target session on the client end. The target message is triggered for the target object, and includes a keyword set. The target object indicates the object whose information the user wants to view. The keyword set can include one or more keywords. The keywords in the keyword set are used to indicate the information that the user wants to view.

In the embodiment of the present disclosure, the target object can be employees who meet the needs of users or other objects.

In the embodiment of the present disclosure, the target message is a message directed towards a target object. According to the target message, the server terminal can determine the object whose information the user wants to view (that is, the target object). In order to enable the server terminal to determine the target object according to the target message, the target message can include relevant information of the target object. In the embodiment of the present disclosure, the relevant information of the target object can include the identification or object retrieval information of the target object. That is, the target information can include the identification information of the target object, and can also include the object retrieval information. These cases are respectively introduced below.

In a first implementation, the target information includes identification information of the target object.

The identification information of the target object is used for identifying the target object. The server terminal can determine the target object according to the identification information of the target object.

Optionally, the identification information of the target object can be used to uniquely identify the target object. For example, the identification information of the target object can include any one or more of the job number of the target object, the object number of the target object, and other types of information. Accordingly, after the target message is obtained, the server terminal can uniquely determine the target object according to the identification information of the target object.

Alternatively, although the identification information of the target object can identify the target object, the server terminal may not be able to uniquely determine the target object according to the identification information of the target object. For this reason, the server terminal can interact with the client terminal one or more times.

Specifically, the server terminal can firstly determine at least one candidate object according to the identification information of the target object, and obtain the information of the candidate object(s). Then, the server terminal can determine object confirmation request information according to the information of the at least one candidate object, and send the object confirmation request information to the client terminal. The client terminal can display object confirmation display content to the user according to the object confirmation request information. The object confirmation display content is used to display the information of the at least one candidate object, and for example, it can include a business card corresponding to each candidate object. The user can browse the object confirmation display content and select the target object from the at least one candidate object. According to the target object selected by the user, the client terminal can generate object confirmation response information that indicates the target object, and send the object confirmation response information to the server terminal. In this way, the server terminal can determine the target object from multiple candidate objects according to the indication of the object confirmation response information.

If the server terminal interacts with the client terminal for multiple times, the messages sent by the client terminal to the server terminal in the multiple times of interaction can be collectively referred to as a target message.

In a second implementation, the target information includes object retrieval information.

The object retrieval information is used to describe the conditions that the object to be retrieved needs to meet, and indicates the demand intention of the object to be retrieved. In the embodiment of the present disclosure, the object retrieval information can be described based on unstructured language, that is, the object retrieval information can be unstructured information. Because the object retrieval information is unstructured information, the server terminal may not be able to directly process the object retrieval information. Therefore, the server terminal can invoke the second model to process the object retrieval information.

Optionally, the object retrieval information can be implemented based on natural language. That is, when searching for an object that meets certain conditions, the user can describe the above-mentioned “certain conditions” in natural language and send the natural language description to the server terminal through the client terminal. Alternatively, the object retrieval information can also include card information.

If the target information includes object retrieval information, the server terminal can parse the target message and determine the object retrieval information after obtaining the target message. Then, the server terminal can determine intention parse information according to the object retrieval information and send the intention parse information to the second model. The second model can parse the user's intention according to the object retrieval information in the intention parse information, generate intention information corresponding to the object retrieval information and send it to the server terminal. The server terminal can receive the intention information returned by the second model and determine the target object according to the intention information. The second model can be a model with NLP capability. The method for the server terminal to invoke the third model to determine the target object can be seen below, and will not be repeated here.

In the embodiment of the present disclosure, the keyword set can be described based on unstructured language, that is, the keywords in the keyword set can be unstructured information. For example, the keyword set can be implemented based on natural language. That is, when certain information of the target object needs to be displayed, the user can describe the above-mentioned “certain information” in natural language, and send the natural language description to the server terminal through the client terminal. The introduction of keywords can be seen below, and will not be repeated here.

The target session is introduced below.

According to the foregoing introduction, the client terminal can be a client terminal of the IM software, and the server terminal can be a server terminal of the IM software, so the above-mentioned target message can be an IM message sent by the client terminal, and the IM message can include a keyword set, and can also include relevant information of the target object and/or the keyword set.

Optionally, the user can send the target message in an IM individual chat session or an IM group chat session. The target session can be an IM individual chat session or an IM group chat session. These cases are respectively introduced below.

In a first implementation, the target message is sent by the user in an IM individual chat session.

Optionally, the user can send the target message through an IM individual chat session corresponding to an intelligent assistant. The intelligent assistant can be a preset service interface, and the user can invoke a corresponding service through interaction with the intelligent assistant. Optionally, the above service can include a service for retrieving the target information of the target object. In some possible implementations, a model can be invoked to determine the target information of the target object, and the intelligent assistant can be the service interface corresponding to the service of invoking the model. For example, the intelligent assistant can be a preset IM conversation robot. The IM message sent by the user to the intelligent assistant can be sent from the client terminal to the server terminal, processed by the server terminal and then forwarded to the model.

Alternatively, the user can send the target message in other IM individual chat sessions and arouse the intelligent assistant to parse the target message. Accordingly, after obtaining the operation triggered by the user to arouse the intelligent assistant to parse the target message, the client terminal can send the target message to the server terminal, so that the server terminal can invoke the first model to parse the target message. The introduction of this part of content can be seen below, and will not be repeated here.

In some embodiments of the present disclosure, the information of the target object can be carried in the target message through a combination of a preset identification and an object name. When a message containing a preset identification and an object name is received in the target session, the preset identification and the object name are displayed in a non-reminder style, that is, no message reminder will be sent to the target object.

In a second implementation, the target message is sent by the user in an IM group chat session.

Optionally, the user can send the target message in the IM group chat session and arouse the intelligent assistant to parse the target message. Accordingly, after obtaining the operation triggered by the user to arouse the intelligent assistant to parse the target message, the client terminal can send the target message to the server terminal, so that the server terminal can invoke the first model to parse the target message.

Specifically, the user can send a target message in an IM group chat session. Then, the user can trigger an operation directed towards the target message to arouse the intelligent assistant to parse the target message. For example, the user can firstly trigger a right-click operation on the target message to arouse the client terminal to display a operation control menu. Then, the user can trigger an operation on the control corresponding to the intelligent assistant in the operation control menu, so as to trigger the target message to be parsed through the intelligent assistant.

S202: Obtaining target information of the target object according to the keyword set.

After the target message is obtained, the target message can be parsed to determine the target object and the keyword set. Then, the target information of the target object can be obtained according to the keyword set.

Firstly, the target information is introduced.

In the embodiment of the present disclosure, the keyword set can include overview keywords and/or index keywords. The overview keyword corresponds to the overview of the target object, and the index keyword corresponds to a specific index of the target object. When obtaining the target information, the server terminal can obtain the overview information of the target object according to the overview keywords, and obtain the index information of the target object according to the index keywords.

The overview information can include basic work information, work content, work ability and work performance information, etc. The index information can include personnel information, performance information, recruitment information, Objectives and Key Results (OKR) information, salary information, etc.

After receiving the target message, the client terminal can forward the target message to the server terminal. The server terminal can obtain the target information of the target object according to the target message, and return the target information of the target object to the client terminal through information viewing response. The specific implementation of the server terminal to obtain the target information of the target object according to the keyword set is introduced below.

Specifically, the server terminal can obtain the target information of the target object according to the requirements of the keyword set. In this way, information is obtained according to the user's needs, the information that meets the needs can be displayed to the user.

Optionally, the target information of the target object can be determined through keyword matching.

Specifically, the information of the object can be determined into a plurality of fields in advance according to the type of the information, and each field can correspond to a piece of information of the object. For example, the employee's working time in this company can correspond to the field “Serving Age” and the employee's work experience can correspond to the field “Work Experience”. The value of a field indicates the actual situation of the employee. For example, the value of the field “Serving Age” of employee A indicates the time that employee A has worked in this company. The value of the field “Education Experience” of employee A can include multiple education experiences of employee A.

The association relationship between keywords and fields can be pre-established on the server terminal. After the information viewing request is obtained, the keywords in the keyword set can be matched one by one to determine the fields corresponding to the keywords. After a field corresponding to a keyword is determined, the value of the target object in this field can be obtained, and the information of the target object corresponding to the keyword can be obtained.

For example, assuming that the user wants to inquire about the serving age and work experience of employee A, and the user can send an IM message “Help me check the serving age and work experience of employee A” to the intelligent assistant on the IM client terminal. The server terminal can determine the target object “Employee A” and the keyword set according to the IM message sent by the user. The keyword set includes the keyword “Serving Age” and the keyword “Work Experience”.

According to the keyword “Serving Age”, the server terminal can obtain the value of employee A in the field of “Serving Age”. According to the keyword “Work Experience”, the server terminal can obtain the value of employee A in the field of “Work Experience”. In this way, the server terminal can obtain the serving age information and work experience information of employee A according to the needs of the user.

In actual scenarios, the user's intention may be complicated, and is difficult to be associated with specific fields through preset rules. In other words, through keyword matching, the server terminal may not be able to determine which fields of information the user needs.

For example, assuming that the user wants to know the English level of employee A, the user can send an IM message “Help me check the English level of employee A” to the intelligent assistant on the IM client terminal. The server terminal can determine the target object “Employee A” and the keyword set according to the IM message sent by the user. The keyword set includes the keyword “English Level”.

However, it is difficult to express the English level of an employee through specific fields. For example, if employee A has a certain professional skill certificate in English, employee A can be regarded as an object with high English level; if employee A has work experience in English-speaking countries, employee A can also be regarded as an object with high English level; if the nationality of employee A is an English-speaking country, employee A can also be regarded as an object with high English level; if the work experience of employee A includes work experience of working with objects from English-speaking countries, employee A can also be regarded as an object with high English level.

In the above example, the keyword “English Level” may correspond to the fields “Nationality”, “Work Experience” and “Professional Skill Certificate”. Moreover, some values in the field may be related to the keyword, while other values may not be related to the keyword. For example, in the field “Work Experience”, the values related to English-speaking countries are related to the keyword “English Level”, while other values are not related to the keyword “English Level”.

It can be seen that because the user's intention is vague, one keyword may correspond to multiple fields, and also to specific values in the fields. In this way, it is difficult to define the association relationship between keywords and fields through preset rules, which may lead to the server not being able to determine the target information through keyword matching.

For this reason, in the embodiment of the present disclosure, intention diffusion can be performed on the keywords, and the keywords can be diffused to specific values of specific fields, and then the target information can be determined according to the specific values of the specific fields.

Specifically, after determining the keyword set, the server terminal can firstly judge whether each keyword in the keyword set can be used for keyword matching. If a keyword can be used for keyword matching, the server terminal can determine the target information corresponding to the keyword through keyword matching. If a keyword cannot be used for keyword matching, for example, if the keyword is not included in the preset matching rule, the server terminal can perform intention diffusion on the keyword to determine the target information corresponding to the keyword.

Optionally, the server terminal can invoke a model for intention diffusion. The model invoked by the server terminal can be a model with NLP capability, for example, can be a language model. Optionally, this model can be called the first model. The first model and the aforementioned second model can be the same model or different models.

Specifically, the server terminal can firstly determine a plurality of keywords that need intention diffusion, and conduct intention diffusion on each keyword separately. Optionally, the server terminal can generate a prompt message according to the plurality of keywords and send it to the first model, so that the first model can conduct intention diffusion on the plurality of keywords simultaneously. Alternatively, the server terminal can generate a plurality of prompt messages according to each keyword that needs intention diffusion, and send the plurality of prompt messages to the first model, so that the first model can conduct intention diffusion on each keyword separately.

The following takes performing intention diffusion on a first keyword in the keyword set as an example for illustration.

After determining that the first keyword needs intent diffusion, the server terminal can obtain intent diffusion information according to the first keyword. The intention diffusion information can be a prompt message. The intention diffusion information includes the first keyword, which indicates that the server terminal invokes the second model to conduct intention diffusion on the first keyword. Optionally, the intention diffusion information can further include instruction information and/or example information. The instruction information is used to instruct the first model to conduct intention diffusion according to the first keyword. The example information can be used as an example to guide the first model to conduct intentional diffusion. For example, the example information can include keywords before diffusion and keywords after diffusion.

According to the intention diffusion information, the first model can conduct intention diffusion on the first keyword, so as to determine which fields can reflect the characteristics of the object on the first keyword. Specifically, the first model can determine at least one diffusion keyword according to the first keyword. The diffusion keyword is obtained by performing intentional diffusion on the first keyword. The characteristics of the object on the first keyword can be obtained through the diffusion keyword. That is to say, if a certain object meets the conditions of the diffusion keyword, it can be considered that the object has the characteristics required by the first keyword.

Optionally, each diffusion keyword can include a plurality of sub-keywords. For example, the diffusion keyword can include a sub-keyword for indicating the field and at least one sub-keyword for indicating the value of the field. The sub-keyword used to indicate the field represents the segment corresponding to the first keyword, and the sub-keyword used to indicate the value of the field represents the specific part of the value in the field when the conditions required by the first keyword are met. The introduction of this part of content can be seen below, and will not be repeated here.

After the intention diffusion is performed according to the first keyword, the first model can send intention diffusion result information to the server terminal. The intention diffusion result information can be generated according to the diffusion keywords obtained by the above-mentioned intention diffusion, and for example, can include at least one diffusion keyword obtained according to the diffusion of the first keyword. In this way, according to the intention diffusion result information, the server terminal can map the keyword (e.g., the first keyword), which cannot be mapped to a certain field (or multiple fields), to one or more specific fields, that is, the fields indicated by the diffusion keywords.

After performing intention diffusion on the keyword, the server terminal can obtain the information of the target object according to the keyword after the intention diffusion. In the embodiment of the present disclosure, information obtained according to diffusion keywords can be called diffusion information. Optionally, if the server terminal obtains a plurality of diffusion keywords, the server terminal can obtain diffusion information corresponding to each diffusion keyword separately.

That is to say, the server terminal can firstly perform intention diffusion on the keyword to obtain diffusion keywords, and then the server terminal can obtain diffusion information according to the diffusion keywords, so as to obtain the target information of the target object.

In the embodiment of the present disclosure, the server terminal can obtain the diffusion information corresponding to the diffusion keywords from the database. That is, the server terminal can obtain the diffusion information from the fields indicated by the diffusion keywords. Optionally, if the fields indicated by the diffusion keywords include a lot of information, the server terminal can filter out fields related to the diffusion keywords from the information corresponding to the fields.

For example, assuming that the first keyword includes “English Level”, the intention diffusion of the first keyword can at least obtain the diffusion keyword A and the diffusion keyword B.

The diffusion keyword A can include a sub-keyword for indicating the field “Nationality” and at least one sub-keyword for indicating the nationality in English. In this way, when obtaining diffusion information according to the diffusion keyword A, the server terminal can obtain, according to the sub-keyword for indicating the “Nationality” of the resource, information corresponding to the target object field “Nationality”, that is, the nationality information of the target object. Due to the low complexity of nationality information, the server may not filter the nationality information of the target object.

The diffusion keyword B can include a sub-keyword for indicating the field “Education Experience” and at least one sub-keyword for indicating studying abroad in an English-speaking country. The above sub-keyword used to indicate studying abroad in an English-speaking country can include information such as the country name, the region name and the college name of the English-speaking country, etc. In this way, when obtaining diffusion information according to the diffusion keyword B, the server terminal can obtain, according to the sub-keyword for indicating the “Education Experience” of the resource, information corresponding to the target object field “Education Experience”, that is, the education experience information of the target object.

In actual scenarios, the education experiences of an employee are often complicated. It will be too redundant to display all the education experiences of the target object. Therefore, the server terminal can filter the education experience information of the target object according to the diffusion keywords, so as to determine the part of the education experiences of the target object that can reflect the “English Level”. Specifically, the server terminal can further filter the education experiences of the target object according to the above-mentioned “at least one sub-keyword for indicating studying abroad in an English-speaking country”, so as to determine the part related to “English Level”. That is to say, if the target object has multiple education experiences, the server terminal can filter out the part related to the information such as the country name, the region name and the college name of the English-speaking country, etc., from the multiple education experiences of the target object, and obtain the corresponding diffusion information.

In some possible implementations, diffusion information may come from different information sources. Specifically, in actual scenarios, information related to objects can be stored in different databases. Accordingly, the server terminal can obtain the target information of the target object from multiple data sources.

For example, basic information of an object, such as employee's name, job number, nationality, education experience and work experience, etc., can be stored in a human resource database. Accordingly, if the diffusion information includes any one of the above information, the information source of the diffusion information can include the human resource database.

Other information of the object may come from other databases. For example, employee's performance information, employee's salary information and employee's OKR information, etc., may not be simultaneously stored in the human resource database, but rather stored through separate databases. If the diffusion information includes the above information, the information source of the diffusion information can further include information sources other than the human resource database.

After obtaining the target information of the target object, the server terminal can generate an information viewing response according to the target information of the target object and send the information viewing response to the client terminal. The client terminal can display the information of the target object to the user according to the information viewing response, so that the user can view the information of the target object.

That is to say, if a user wants to view certain information of a certain object (or multiple objects), the user can send his/her own needs to the server terminal through the client terminal, and the server terminal can determine the appropriate target information and return it to the client terminal for the client to display. In this way, the server terminal can determine what information needs to be displayed to the user according to the user's needs, without the need for the user to manually retrieve the information to be viewed. Thus, automatic information retrieval can be achieved by parsing the user's intention, and the retrieval efficiency can be improved.

In the embodiment of the present disclosure, the information viewing response can include the target information of the target object or summarized target information of the target object. If the information viewing response includes the summarized information of the target object, the server terminal can summarize the target information of the target object first. The following is a detailed introduction.

In actual scenarios, the display region of the client terminal is limited. If the length of the target information of the target object is too long, it may not be convenient to display on the client terminal. For this reason, the user may need to adjust the content displayed on the client terminal by sliding a control to see the complete target information, and the operation is cumbersome. Moreover, the amount of information displayed is too large, and it is not convenient for the user to find key information therefrom. Therefore, the server terminal can summarize the target information of the target object to extract the valuable information of the target object.

Optionally, the server terminal can summarize the target information through a model. In the embodiment of the present disclosure, the model used for summarizing the target information can be called a third model. The third model can be a model with NLP capability, and for example, can be a language model. Optionally, the third model, the first model and the second model can be the same model or different models.

Specifically, when summarizing through the third model, the server terminal can firstly generate object summary information according to the information of the target object. Then, the server terminal can send the object summary information to the third model. The object summary information can be a prompt message. According to the object summary information, the third model can summarize the target information of the target object to obtain the summarized target information of the target object. Next, the third model can generate object summary response information according to the summarized target information of the target object, and send the object summary response information to the server terminal. According to the object summary response information, the server terminal can generate an information viewing response.

Optionally, if the target information of the target object comes from multiple information sources, the information viewing response can further include link instruction information and links of the information sources. The link of an information source can be used to access the information source, and for example, it can include the Uniform Resource Locator (URL) of the information source. The link instruction information is used to instruct the client to display the link of the information source.

In other words, the server terminal can not only instruct the client terminal to display the information coming from the information sources, but also instruct the client terminal to display the links corresponding to the information sources. In this way, the user can access the information source through the link corresponding to the information source, so as to view the information of the target object in the information source. Particularly, if the client terminal displays the summarized target information to the user, the user can view the target information of the target object before being summarized through the link corresponding to the information source.

In the embodiment of the present disclosure, if the user triggers an operation of accessing the information source, the client terminal can display the information corresponding to the information source in the target session, or jump to an information page corresponding to the information source and display the information corresponding to the information source in the information page. That is, the client terminal can display the content of the diffusion information in the target session in response to a first trigger operation on the diffusion information of the reference region. Alternatively, the client terminal can also invoke an information page of the information source of the diffusion information in response to a second trigger operation on the diffusion information of the reference region, and display the content of the diffusion information on the information page.

S203: Displaying a reply message, which contains the target information, in the target session.

After obtaining the target information of the target object, the client terminal can display a reply message containing the target information in the target session. In this way, the user can know the target information of the target object by viewing the reply message.

Specifically, if the client terminal is a client terminal of the IM software, the client terminal can show the display content to the user in the IM session. The display content is generated according to the target information of the target object. For example, the display content can be generated according to the aforementioned overview information and index information. Optionally, the display content can be generated by the client terminal according to the target information sent by the server terminal, or generated by the server terminal according to the target information and sent to the client terminal.

In the embodiment of the present disclosure, the client can display the above display contents in the form of a graph, a table or an information card. The information card is taken as an example for illustration below.

For example, the client terminal can generate an information card according to the information viewing response and display the information card to the user in the IM session. The information card can be used to display the target information of the target object to the user.

Optionally, if the object retrieval information is sent by the user in the IM individual chat session corresponding to the intelligent assistant, the client terminal can display the information card in the current IM session. Alternatively, if the object retrieval information is sent by the user in the IM individual chat session not corresponding to the intelligent assistant, the client terminal can display the information card in the current IM session, or jump to the IM individual chat session corresponding to the intelligent assistant and display the information card in the IM individual chat session corresponding to the intelligent assistant.

Optionally, if there are multiple target objects, the client terminal can display multiple information cards, and each information card is used to display the relevant information of one target object. Alternatively, the information card displayed by the client terminal can further include multiple sub-cards, and each sub-card is used to display the target information of one target object.

In some implementations, the target object may have a large amount of target information. A large display region may be needed to completely display the target information of the target object. For this reason, the user experience of a user who uses the client terminal may be affected. Therefore, in some implementations, the target information of the target object can also be displayed in abbreviated form. Moreover, after obtaining the information expansion display operation triggered by the user, the complete target information of the target object can be displayed to the user.

For example, a word count threshold and/or a line count threshold can be preset. If the word count of a certain item of target information of the target object reaches the word count threshold, and/or the line count of a certain item of target information of the target object reaches the line count threshold, the client terminal can display this item of target information in abbreviated form. For example, target information within the word count threshold can be displayed, and/or target information within the line count threshold can be displayed. Optionally, the client terminal can further display an information expansion control, and the user can trigger an information expansion operation through the information expansion control.

After obtaining the information expansion operation triggered by the user directed towards a certain item of target information of the target object, the client terminal can display the complete target information. For example, the client terminal can expand the display region of the current page for displaying this item of target information, so as to display the complete target information through a larger display region. Alternatively, the client terminal can jump to other pages or pop up sub-pages, so as to display the complete target information through the jumped or popped-up pages.

In some implementations, the user may not be sure the target information of which target objects he/she needs to view specifically. Accordingly, the server terminal can determine multiple target objects and obtain the target information of the multiple target objects according to the needs of the user. Accordingly, the information viewing response sent by the server terminal to the client terminal can include the target information of the multiple target objects. The client terminal can display the target information of the multiple target objects according to the information viewing response.

In actual scenarios, the number of target objects may be relatively large. Thus, it may be inconvenient for the user to view if the target information of all of the target objects is displayed at once. Moreover, it may need more network resources if the server terminal sends the target information of all of the target objects to the client terminal at once. For this reason, in some possible implementations, the object display information that the server terminal can send to the client terminal can be generated based on the information of some target objects, and the client terminal can display the relevant information of some target objects to the user.

For example, if the server determines N target objects (N is a positive integer), the server terminal can firstly select M target objects (M is a positive integer less than N) from the N target objects, and then generate an information retrieval response according to the target information of the selected M target objects and send it to the client terminal. In this way, the client terminal may only display the target information of the M target objects without displaying the target information of the N target objects at once.

In the above example, the server terminal can determine the target object whose relevant information is displayed according to the correlation between the target object and the object retrieval information. The object retrieval information is the relevant information used by the server terminal to search for the target object. The introduction of object retrieval information can be referred to the following, and will not be repeated here.

For example, the selected M target objects can be M target objects with the highest correlation with the object retrieval information among the N target objects. Optionally, the correlation between the target object and the object retrieval information can be determined based on a model, and for example, the correlation between the target object and the object retrieval information can be determined through the model. The introduction of this part of content can be seen below, and will not be repeated here.

If the client terminal displays the target information of some target objects to the user, in some scenarios, the target objects displayed by the client terminal to the user may not meet the user's needs. For this reason, the user may want to view other target objects. Therefore, when displaying the target information of some target objects, the client terminal can further display an object expansion control. After the user triggers the object expansion control, the client terminal can send a data obtaining request to the server terminal. The server terminal can generate a new information retrieval response according to the data obtaining request sent by the client terminal and send the new information retrieval response to the client terminal. The above new information retrieval response can be determined according to the target information of all of the target objects.

Optionally, the object expansion control can be a control in the information card for displaying the target information of the target object, or an independent information card.

In the implementation described above, the server terminal can firstly send the target information of a part of the target objects to the client terminal, and then send the target information of another part of the target objects to the client terminal according to the operation triggered by the user. In some other possible implementations, the server terminal can also send the target information of all of the target objects to the client terminal, and the client terminal only displays the target information of a part of the target objects at once. After the user triggers the operation, the client terminal can display the target information of another part of the target objects.

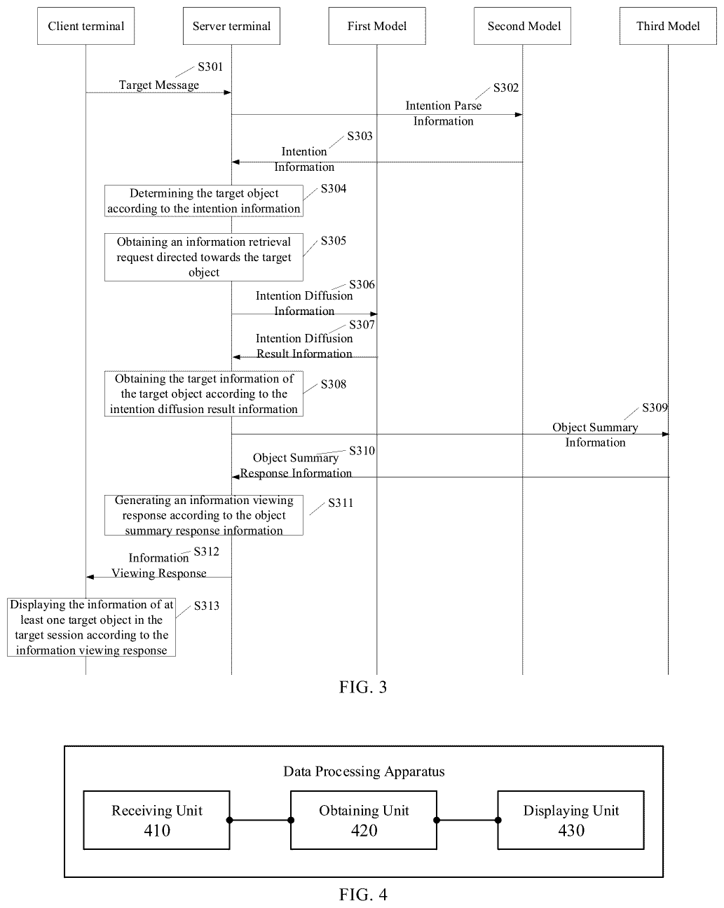

The implementation of determining the target information of the target object is described above, and it will be described in detail with reference to FIG. 3 below.

Referring to FIG. 3, it is a schematic diagram of an implementation of determining target information of a target object provided by an embodiment of the present disclosure. In the implementation corresponding to FIG. 3, the client terminal can send the object retrieval information and the keyword set to the server terminal, and the server terminal can invoke the second model to determine the target object and invoke the first model to determine the target information of the target object.

As shown in FIG. 3, the method specifically includes the following steps:

S301: The client terminal sends a target message to the server terminal.

If the user wants to view the target information of the target object on the client terminal, the user can send the target message to the server terminal through the client end. The target message includes object retrieval information and a keyword set. The object retrieval information is used to describe the target object, and the keyword set is used to describe the target information.

S302: The server terminal sends intention parse information to the second model.

After receiving the target message sent by the client terminal, the server terminal can parse the target message, firstly determine the target object, and then obtain the target information of the target object. In the implementation shown in FIG. 3, the target message does not explicitly indicate the target object, but describes the conditions that the target object possesses through the object retrieval information, so that the server terminal cannot directly determine the target object according to the target message. Therefore, the server terminal can invoke the second model to parse the object retrieval information, so as to determine the target object that meets the requirements of the object retrieval information.

Specifically, the server terminal can generate intention parse information according to the object retrieval information, and then send the intention parse information to the second model. The second model can parse the object retrieval information according to the intention parse information, so as to determine the user's intention.

S303: The second model sends intention information to the server terminal.

After obtaining the intention parse information, the second model can parse the object requirements in the intention parse information, so as to determine the intention information and send it to the server terminal. The intention information is used to indicate the intention of the user sending the object retrieval information, indicating that the user wants to obtain the information of those objects.

S304: The server terminal determines the target object according to the intention information.

After obtaining the intention information, the server terminal can determine the target object according to the intention information. The target object is an object that satisfies the user's intention.

Specifically, the server terminal can determine condition information according to the intention information, and then filter out an object that meets the condition information from the objects as the target object.

In actual scenarios, the user may put forward various requirements for the target object. Moreover, the complexity of a part of the user's requirements for the target object is high, while the complexity of another part of the user's requirements for the target object is low. Therefore, in some possible implementations, the condition information can be classified, and different processing methods can be used to process the condition information.

Optionally, part of the user's intention may be explicit and can correspond to a specific value of a specific field. For example, the user's requirements for the values of fields such as “Serving Age” and “Nationality”, etc., are often precise. Accordingly, the condition information can match the value of the field. In the embodiment of the present disclosure, such precise intentions can be called first type intentions, and the condition information corresponding to the first type intentions can be called first type condition information.

If the server terminal determines the first type condition information according to the intention information, the server terminal can firstly filter, according to the first type condition information, to determine a first candidate object set. The first candidate object set can include at least one first candidate object. The first candidate object satisfies the first type condition information.

Optionally, part of the user's intention may be inexplicit and cannot correspond to specific values, but the user's intention can correspond to specific fields. For example, for fields such as “Education Experience” and “Work Experience”, etc., their values are flexible, and it is difficult to accurately map the user's requirements to the specific values of the fields. For this reason, in the embodiment of the present disclosure, the user's requirements for these types of fields can be called second type intention information, and the condition information corresponding to the second type intention information can be called second type condition information.

If the server terminal determines the second type condition information according to the intention information, the server terminal can filter the first candidate object set according to the second type condition information, so as to determine a second candidate object set. The second candidate object set can include at least one second candidate object. The second candidate object satisfies the first type condition information and the second type condition information.

Specifically, the server terminal can vectorize the value of the field and determine the second candidate object through vector matching. That is to say, for the field indicated by the second type condition information, the vector of the value of the second candidate object in the field matches the vector required by the second type condition information.

Optionally, the user's intention may not correspond to a specific field. For example, if the user's intention includes “Finding employees with high English level”, the intention cannot be mapped to a specific field, nor can it be mapped to a specific value of a field. In the embodiment of the present disclosure, the user's requirements for fields that cannot be mapped can be called third type intention information, and the condition information corresponding to the third type intention information can be called third type condition information.

Optionally, the server terminal can invoke a model to determine the third type condition information. Specifically, the server terminal can invoke a model to conduct intention diffusion on the third type intention information, so as to determine the intention redisplayed in order for satisfying the third type intention information and obtain the third type condition information. Optionally, the server terminal can invoke the first model to conduct intention diffusion, and can also invoke other models to conduct intention diffusion.

If the server terminal determines the third type condition information according to the intention information, the server terminal can filter the second candidate object set according to the third type condition information, so as to determine a third candidate object set. The third candidate object set includes at least one third candidate object. The third candidate object satisfies the first type condition information, the second type condition information and the third type condition information.

After determining the third candidate object set, the server terminal can determine the third candidate object as the target object. Alternatively, the server can also verify the third candidate object according to the object retrieval information. In this way, by further combining the object retrieval information to verify the third candidate object that may be determined as the target object, it can further ensure that the target object meets the needs of the user. Optionally, the server terminal can invoke a model to verify the third candidate object.

S305: The server terminal obtains an information retrieval request directed towards the target object.

After determining the target object, the server terminal can obtain the information retrieval request directed towards the target object. For example, the server terminal can generate an information retrieval request according to the target object and the keyword set.

S306: The server terminal sends intention diffusion information to the first model.

According to the information retrieval request, the server terminal can generate intention diffusion information and send it to the first model. The intention diffusion information includes keywords that need intention diffusion.

S307: The first model sends intention diffusion result information to the server terminal.

After receiving the intention diffusion information, the first model can conduct intention diffusion on the keywords to obtain at least one diffusion keyword, and return the intention diffusion result information to the server terminal. The intention diffusion result information can include the at least one diffusion keyword mentioned above.

S308: The server terminal obtains the target information of the target object according to the intention diffusion result information.

After obtaining the intention diffusion result information, the server terminal can determine the diffusion keywords according to the intention diffusion result information, and then search for information that matches the diffusion keywords from the information source to obtain the diffusion information of the target object. In addition, for keywords that do not need intention diffusion, the server terminal can obtain the target information of the target object from the information source according to the keywords.

S309: The server terminal sends object summary information to the third model.

After obtaining the target information of the target object according to keywords and/or diffusion keywords, the server terminal can summarize the target information of the target object through the third model. Specifically, the server terminal can generate the object summary information according to the target information of the target object, and send the object summary information to the third model.

S310: The third model sends object summary response information to the server terminal.

After obtaining the object summary information, the third model can summarize the target information of the target object, so as to generate the object summary response information and send it to the server terminal. The object summary response information can include the summarized target information of the target object. The correlation between the summarized target information of the target object and the keywords is higher than the correlation between the target information of the target object before being summarized and the keywords.

S311: The server terminal generates an information viewing response according to the object summary response information.

After receiving the object summary response information returned by the third model, the server terminal can generate an information viewing response according to the object summary response information. The information viewing response is used to instruct the server terminal to display the summarized target information of the target object.

Optionally, if the target information of the target object comes from multiple information sources, the information viewing response can further include links corresponding to the information sources and link instruction information, so as to instruct the client terminal to display the links corresponding to the information sources.

S312: The server terminal sends the information viewing response to the client terminal.

After generating the information viewing response, the server terminal can send the information viewing response to the client terminal, so as to instruct the client terminal to display the information of the target object to the user.

S313: The client terminal displays the information of at least one target object in the target session according to the information viewing response.

After obtaining the information viewing response, the client terminal can display the information of at least one target object to the user according to the information viewing response. In this way, for the user who uses the client terminal, if he/she need to view partial information of some objects, he/she only needs to send his/her own requirements to the server terminal through the client terminal to see the information that needs to be viewed on the client terminal, without retrieving the corresponding information from the database in person. Thus, the efficiency of information viewing is improved.

Based on the data processing method provided by the above method embodiments, an embodiment of the present disclosure further provides a data processing apparatus, which can run on the server terminal. The data processing apparatus will be described with reference to the accompanying drawings below.

Referring to FIG. 4, it is a schematic structural diagram of a data processing apparatus provided by an embodiment of the present disclosure. As shown in FIG. 4, the data processing apparatus includes:
a receiving unit 410, configured to receive a target message for a target object in a target session, wherein the target message includes a keyword set;
an obtaining unit 420, configured to obtain target information of the target object according to the keyword set, wherein the target information matches keywords in the keyword set;
a displaying unit 430, configured to display a reply message, which contains the target information, in the target session.

In some possible implementations, the keyword set includes overview keywords and/or index keywords.

In some possible implementations, the obtaining unit 420 is specifically configured to: obtain overview information of the target object according to the overview keywords, wherein the overview information includes at least one of the following items: basic work information, work content, work ability and work performance; or, obtain index information of the target object according to the index keywords, wherein the index information includes at least one item of the following items: personnel information, performance information, recruitment information, OKR information and salary information.

In some possible implementations, the displaying unit 430 is specifically configured to display a graph, a table and/or an information card in the reply message, wherein the graph, the table and/or the information card are generated based on the overview information or the index information.

In some possible implementations, the obtaining unit 420 is specifically configured to: send intention diffusion information to a first model, wherein the intention diffusion information is obtained according to a first keyword in the keyword set; receive intention diffusion result information sent by the first model, wherein the intention diffusion result information includes at least one diffusion keyword, and the diffusion keyword is obtained by performing intention diffusion on the first keyword; query, according to the at least one diffusion keyword, to obtain diffusion information of the target object, wherein the target information includes the diffusion information.

In some possible implementations, the obtaining unit 420 is specifically configured to obtain diffusion information of the target object from an information source corresponding to the diffusion keyword.

In some possible implementations, the reply message further includes a reference region, and the reference region is used to display the diffusion information of the target object.

In some possible implementations, the reference region includes at least one item of the following diffusion information: personnel information, performance information, recruitment information, OKR information and salary information.

In some possible implementations, the displaying unit 430 is further configured to: display, in response to a first trigger operation on the diffusion information of the reference region, a content of the diffusion information in the target session; or, invoke, in response to a second trigger operation on the diffusion information of the reference region, an information page of the information source of the diffusion information, and display the content of the diffusion information on the information page.

In some possible implementations, the keyword set further includes a second keyword, and the obtaining unit 420 is specifically configured to query, according to the second keyword, to obtain accurate information of the target object, wherein the target information further includes the accurate information.

In some possible implementations, the target information includes identification information of the target object.

In some possible implementations, the obtaining unit 420 is further configured to: determine at least one candidate object according to the identification information; send object confirmation request information to a client terminal, wherein the object confirmation request information is obtained according to information of the at least one candidate object; obtain object confirmation response information sent by the client terminal, wherein the object confirmation response information indicates the target object; and determine the target object according to the object confirmation response information.

In some possible implementations, the target information includes object retrieval information; the obtaining unit 420 is further configured to: send intention parse information to a second model, wherein the intention parse information is generated based on object retrieval information; receive intention information sent by the second model, wherein the intention information is determined according to the object retrieval information; and determine the target object according to the intention information, wherein information of the target object matches the intention information.

In some possible implementations, the obtaining unit 420 is further configured to: send object summary information to a third model, wherein the object summary information is obtained according to the target information of the target object; receive object summary response information sent by the third model, wherein the object summary response information includes summarized target information of the target object; and generate the reply message according to the summarized target information of the target object.

Based on the data processing method provided by the above method embodiments, the present disclosure further provides an electronic device, which includes: one or a plurality of processors; a storage apparatus, storing one or a plurality of programs thereon, wherein the one or plurality of programs, when executed by the one or plurality of processors, cause the one or plurality of processors to realize the data processing method as described in any of the above embodiments.

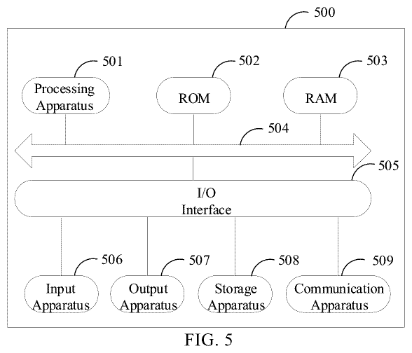

FIG. 5 is specifically referred below, and it shows the structure schematic diagram suitable for achieving the electronic device 500 in the embodiment of the present disclosure. The electronic device 500 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 5 is only an example and should not impose any limitations on the functions and use scopes of the embodiments of the present disclosure.

As shown in FIG. 5, the electronic device 500 may include a processing apparatus (such as a central processing unit, and a graphics processor) 501, it may execute various appropriate actions and processes according to a program stored in a read-only memory (ROM) 502 or a program loaded from a storage apparatus 508 to a random access memory (RAM) 503. In RAM 503, various programs and data required for operations of the electronic device 500 are also stored. The processing apparatus 501, ROM 502, and RAM 503 are connected to each other by a bus 504. An input/output (I/O) interface 505 is also connected to the bus 504.

Typically, the following apparatuses may be connected to the I/O interface 505: an input apparatus 506 such as a touch screen, a touchpad, a keyboard, a mouse, a camera, a microphone, an accelerometer, and a gyroscope; an output apparatus 507 such as a liquid crystal display (LCD), a loudspeaker, and a vibrator; a storage apparatus 508 such as a magnetic tape, and a hard disk drive; and a communication apparatus 509. The communication apparatus 509 may allow the electronic device 500 to wireless-communicate or wire-communicate with other devices so as to exchange data. Although FIG. 5 shows the electronic device 500 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 509, or installed from the storage apparatus 508, or installed from ROM 502. When the computer program is executed by the processing apparatus 501, the above functions defined in the embodiments of the present disclosure are executed.

The electronic device provided by the embodiment of the present disclosure belongs to the same inventive concept as the method provided by the above embodiments, technical details that are not fully described in the present embodiment may be referred to the above embodiments, and the present embodiment has the same beneficial effects as the above embodiments.

Based on the method provided by the above method embodiments, an embodiment of the present disclosure provides a computer-readable storage medium on which a computer program is stored, wherein the program, when executed by a processor, realizes the data processing method as described in any of the above embodiments.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above computer-readable storage medium can be contained in the above electronic device; and it can also exist separately without being assembled into the electronic device.

The above computer-readable storage medium carries one or more programs, and when the above one or more programs are executed by the electronic device, the electronic device can execute the above data processing method.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

It should be noted that each embodiment in the description is described in a progressive manner, and each embodiment focuses on the differences from other embodiments. The same or similar portions between the embodiments may be referred to each other. For the system or apparatus disclosed in the embodiments, the description is relatively simple since it corresponds to the method disclosed in the embodiments. Please refer to a method section for relevant information.

It should be understood that in the present disclosure, “at least one” refers to one or more, and “plurality” refers to two or more. “And/or” is used to describe an association relationship of associated objects, and it represents that there may be three types of relationships. For example, “A and/or B” may represent: only A exists, only B exists, and both A and B exist, wherein A and B may be singular or plural. The character “/” generally represents that the front and rear associated objects are an “or” relationship. “At least one of the following” or similar expressions refer to any combinations of these items, including any combinations of single or plural items. For example, at least one of a, b, or c may represent: a, b, c, “a and b”, “a and c”, “b and c”, or “a and b and c”, wherein a, b, and c may be single or multiple.

It should also be noted that in the present disclosure, relationship terms, such as first and second, etc., are only used to distinguish one entity or operation from another entity or operation, and do not necessarily require or imply any actual relationship or order between these entities or operations. Moreover, the terms “including”, “containing”, or any other variations thereof are intended to encompass non-exclusive inclusion, such that a process, a method, an item, or a device that includes a series of elements not only includes those elements, but also other elements that are not explicitly listed, or also includes elements inherent in such a process, method, item, or device. In the case without more limitations, an element limited by the statement “including one . . . ” does not exclude the existence of other identical elements in the process, method, item, or device that includes the element.

The above description of the disclosed embodiments enables those skilled in the art to implement or use the present disclosure. The various modifications to these embodiments may be apparent to those skilled in the art, and the general principles defined in this article may be achieved in other embodiments without departing from the spirit or scope of the present disclosure. Therefore, the present disclosure may not be limited to the embodiments shown, but rather to the widest scope consistent with the principles and novel features disclosed.

1. A data processing method, comprising:
receiving a target message for a target object in a target session, wherein the target message comprises a keyword set;
obtaining target information of the target object according to the keyword set, wherein the target information matches keywords in the keyword set;
displaying a reply message, which contains the target information, in the target session.

2. The method according to claim 1, wherein the keyword set comprises overview keywords and/or index keywords.

3. The method according to claim 2, wherein the obtaining the target information of the target object according to the keyword set comprises:
obtaining overview information of the target object according to the overview keywords, wherein the overview information comprises at least one selected from a group consisting of: basic work information, work content, work ability and work performance; or,
obtaining index information of the target object according to the index keywords, wherein the index information comprises at least one selected from a group consisting of: personnel information, performance information, recruitment information, OKR information and salary information.

4. The method according to claim 3, wherein the displaying the reply message, which contains the target information, in the target session comprises:
displaying a graph, a table and/or an information card in the reply message, wherein the graph, the table and/or the information card are generated based on the overview information or the index information.

5. The method according to claim 1, wherein the obtaining the target information of the target object according to the keyword set comprises:
sending intention diffusion information to a first model, wherein the intention diffusion information is obtained according to a first keyword in the keyword set;
receiving intention diffusion result information sent by the first model, wherein the intention diffusion result information comprises at least one diffusion keyword, and the diffusion keyword is obtained by performing intention diffusion on the first keyword;
querying, according to the at least one diffusion keyword, to obtain diffusion information of the target object, wherein the target information comprises the diffusion information.

6. The method according to claim 5, wherein the querying, according to the at least one diffusion keyword, to obtain the diffusion information of the target object comprises:
obtaining the diffusion information of the target object from an information source corresponding to the diffusion keyword.

7. The method according to claim 6, wherein the reply message further comprises a reference region, and the reference region is used to display the diffusion information of the target object.

8. The method according to claim 7, wherein the reference region comprises at least one diffusion information selected from a group consisting of: personnel information, performance information, recruitment information, OKR information and salary information.

9. The method according to claim 7, further comprising:
displaying, in response to a first trigger operation on the diffusion information of the reference region, a content of the diffusion information in the target session; or,
invoking, in response to a second trigger operation on the diffusion information of the reference region, an information page of the information source of the diffusion information, and displaying the content of the diffusion information on the information page.

10. The method according to claim 1, wherein the keyword set further comprises a second keyword, and the obtaining the target information of the target object according to the target keyword comprises:
querying, according to the second keyword, to obtain accurate information of the target object, wherein the target information further comprises the accurate information.

11. The method according to claim 1, wherein the target information comprises identification information of the target object.

12. The method according to claim 11, further comprising:
determining at least one candidate object according to the identification information;
sending object confirmation request information to a client terminal, wherein the object confirmation request information is obtained according to information of the at least one candidate object;
obtaining object confirmation response information sent by the client terminal, wherein the object confirmation response information indicates the target object;
determining the target object according to the object confirmation response information.

13. The method according to claim 1, wherein the target information comprises object retrieval information;
the method further comprises:
sending intention parse information to a second model, wherein the intention parse information is generated based on the object retrieval information;
receiving intention information sent by the second model, wherein the intention information is determined according to the object retrieval information;
determining the target object according to the intention information, wherein information of the target object matches the intention information.

14. The method according to claim 1, wherein after obtaining the target information of the target object and before displaying the reply message, the method further comprises:
sending object summary information to a third model, wherein the object summary information is obtained according to the target information of the target object;
receiving object summary response information sent by the third model, wherein the object summary response information comprises summarized target information of the target object;
generating the reply message according to the summarized target information of the target object.

15. An electronic device, comprising:
one or more processors;
a storage apparatus, storing one or more programs thereon,
wherein the one or more programs, when executed by the one or more processors, cause the one or more processors to realize a data processing method, comprising:
receiving a target message for a target object in a target session, wherein the target message comprises a keyword set;
obtaining target information of the target object according to the keyword set, wherein the target information matches keywords in the keyword set;
displaying a reply message, which contains the target information, in the target session.

16. The electronic device according to claim 15, wherein the keyword set comprises overview keywords and/or index keywords.

17. The electronic device according to claim 16, wherein the obtaining the target information of the target object according to the keyword set comprises:
obtaining overview information of the target object according to the overview keywords, wherein the overview information comprises at least one selected from a group consisting of: basic work information, work content, work ability and work performance; or,
obtaining index information of the target object according to the index keywords, wherein the index information comprises at least one selected from a group consisting of: personnel information, performance information, recruitment information, OKR information and salary information.

18. The electronic device according to claim 17, wherein the displaying the reply message, which contains the target information, in the target session comprises:
displaying a graph, a table and/or an information card in the reply message, wherein the graph, the table and/or the information card are generated based on the overview information or the index information.

19. The electronic device according to claim 15, wherein the obtaining the target information of the target object according to the keyword set comprises:
sending intention diffusion information to a first model, wherein the intention diffusion information is obtained according to a first keyword in the keyword set;
receiving intention diffusion result information sent by the first model, wherein the intention diffusion result information comprises at least one diffusion keyword, and the diffusion keyword is obtained by performing intention diffusion on the first keyword;
querying, according to the at least one diffusion keyword, to obtain diffusion information of the target object, wherein the target information comprises the diffusion information.

20. A non-transient computer-readable storage medium, wherein a computer program is stored thereon, wherein the program, when executed by a processor, realizes a data processing method, comprising:
receiving a target message for a target object in a target session, wherein the target message comprises a keyword set;
obtaining target information of the target object according to the keyword set, wherein the target information matches keywords in the keyword set;
displaying a reply message, which contains the target information, in the target session.
